(19) United States
(12) Patent Application Publication
(10) Pub. No.: US 2008/0143645 A1
(43) Pub. Date: Jun. 19, 2008

(54) Method of driving discharge display panel having driving waveform varying in first reset period

(76) Inventor: Jun-Weon Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/985,093

(22) Filed: Nov. 14, 2007

(30) Foreign Application Priority Data
Dec. 19, 2006 (KR) 10-2006-0130381

(51) Int. Cl. G09G 3/28

(52) U.S. Cl. 345/60

(57) ABSTRACT

A method of driving a discharge display panel is disclosed. In the method, a unit frame is divided into sub-fields, where each sub-field has a reset period, an addressing period, and a discharge-sustain period. The number of sustain pulses in the discharge-sustaining period of each of the sub-fields corresponds to gray-scale weighted values of each of the sub-fields and to an average gray-scales of the frame. Additionally, the reset wave form is determined based on the number of sustain pulses in the previous discharge-sustain period.

### CROSS-REFERENCE TO RELATED PATENT APPLICATION

This application claims the benefit of Korean Patent Application No. 10-2006-0130381, filed on Dec. 19, 2006, in the Korean Intellectual Property Office, the disclosure of which is incorporated herein in its entirety by reference.

### BACKGROUND

1. Field of the Invention

The field relates to a method of driving a discharge display panel, and more particularly, to a method of driving a discharge display panel in which a unit frame is time-division driven by a plurality of sub-fields.

2. Description of the Related Technology

In a conventional discharge display device, for example, a plasma display device disclosed in U.S. Pat. No. 5,541,618, a unit frame is time-division driven by a plurality of sub-fields and each of the sub-fields includes a reset period, an addressing period, and a discharge-sustaining period.

The number of sustain pulses is established in the discharge-sustaining period of each of the sub-fields in proportion to corresponding gray-scale weighted values of each of the sub-fields. However, since the conventional discharge display device uses a relatively large maximum power, it is necessary to control the maximum value of driving power varying in proportion to average gray-scales of each of frames. Therefore, the number of sustain pulses established in the discharge-sustaining period of each of the sub-fields is controlled in proportion to corresponding gray-scale weighted values of each of the sub-fields, and in inverse proportion to average gray-scales of each of frames, which is referred to as an automatic power control.

The automatic power control increases the lifetime of the conventional discharge display device and reduces power consumption of the conventional discharge display device since the maximum value of driving power is controlled.

However, since the number of sustain pulses is reduced in proportion to average gray-scales of each of frames, a pause period is generated between an end point of a final sub-field of each of frames and a beginning point of a next frame. Therefore, the higher average gray-scales of each of frames are, the longer the pause period takes. Since no discharge occurs in the pause period, space charges and wall charges are removed from display cells in proportion to the pause period.

According to the automatic power control, the pause period where no discharge occurs is generated in the frames other than a frame having the maximum gray-scale, so that space charges and wall charges are removed at the beginning point of the unit frame in proportion to the pause period. Therefore, in a reset period of a first sub-field of the unit frame, a weak discharge does not gradually occur but a strong weak abruptly occurs when a high voltage is applied. This problem gets worse at a low temperature where a discharge delay time increases.

When the weak discharge does not occur but the strong weak abruptly occurs in the reset period, wall charges for addressing are not sufficiently formed by the end point of the reset period, i.e., a beginning point of the addressing period. Consequently, an erroneous discharge and a low discharge occur during the addressing period, so that the erroneous discharge and the low discharge occur during the discharge-sustain period, which may reduce presentation of a display image.

To address this problem, if a waveform is improved so that the gradual weak discharge more frequently occurs in the reset period of the first sub-field of each of frames, wall charges for addressing are excessively formed at the beginning point of the addressing period, which can reduce quality of the display image.

### SUMMARY OF CERTAIN INVENTIVE ASPECTS

A method of driving a discharge display panel to perform an automatic power control and efficiently increase presentation quality of a display image is disclosed.

One aspect is a method of driving a discharge display panel including sustain electrode-lines, scanning electrode-lines formed alternately with the sustain electrode-lines, address electrode-lines formed to cross the sustain electrode-lines and the scanning electrode-lines, and display cells formed near the crossing electrode-lines, where a unit frame is divided into a plurality of sub-fields, each of the sub-fields including a reset period, an addressing period, and a discharge-sustaining period, one or more sustain pulses applied during the discharge-sustaining period while a constant electric potential is applied to the sustain electrode-lines. The method includes controlling the number of sustain pulses established in the discharge-sustaining period of each of the sub-fields in proportion to corresponding gray-scale weighted values of each of the sub-fields and in inverse proportion to average gray-scales of each frame, and varying a driving waveform of a reset period of a first sub-field in a unit frame.

### BRIEF DESCRIPTION OF THE DRAWINGS

The above and other features and advantages will become more apparent by describing embodiments with reference to the attached drawings in which:

FIG. 1 is a perspective view of a three-electrodes surface discharge type plasma display panel (PDP) operating according to one embodiment;

FIG. 2 is a cross-sectional view of a discharge cell of the PDP illustrated in FIG. 1, according to an embodiment;

FIG. 3 is a timing diagram illustrating a method of driving the PDP illustrated in FIG. 1 according to an embodiment;

FIG. 4 is a waveform diagram illustrating an automatic power control method included in the method illustrated in FIG. 3 according to an embodiment;

FIG. 5 is a block diagram illustrating an apparatus for driving the PDP using the method illustrated in FIG. 3 according to an embodiment;

FIG. 6 is a waveform diagram illustrating driving signals between the beginning of an N^{th} frame FR_{N} and the end of an N−1^{st} frame FR_{N-1}, according to an embodiment;

FIG. 7 is a cross-sectional diagram illustrating a wall charge distribution of one of the display cells of the PDP at time t₄ of the waveform diagram illustrated in FIG. 6, according to an embodiment;

FIG. 8 is a cross-sectional diagram illustrating a wall charge distribution of one of the display cells of the PDP at time t₆ of the waveform diagram illustrated in FIG. 6, according to an embodiment;

FIG. 9 is a waveform diagram illustrating driving signals between the beginning of an N+1^{st} frame FR_{N+1} and the end of the N^{th} frame FR_{N}, according to an embodiment;

FIG. 10 is a waveform diagram illustrating driving signals between the beginning of an N+2^{nd} frame FR_{N+2} and the end of the N+1′ frame FR_{N+1}, according to an embodiment;

FIG. 11 is a waveform diagram illustrating driving signals between the beginning of an N+3^{rd} frame FR_{N+3} and the end of the N+2^{nd} frame FR_{N+2}, according to an embodiment; and

FIG. 12 is a waveform diagram illustrating driving signals between the beginning of an N+4^{th} frame FR_{N+4} and the end of the N+3^{rd} frame FR_{N+3}, according to an embodiment.

### DETAILED DESCRIPTION OF CERTAIN INVENTIVE EMBODIMENTS

Hereinafter, embodiments will be described more fully with reference to the accompanying drawings.

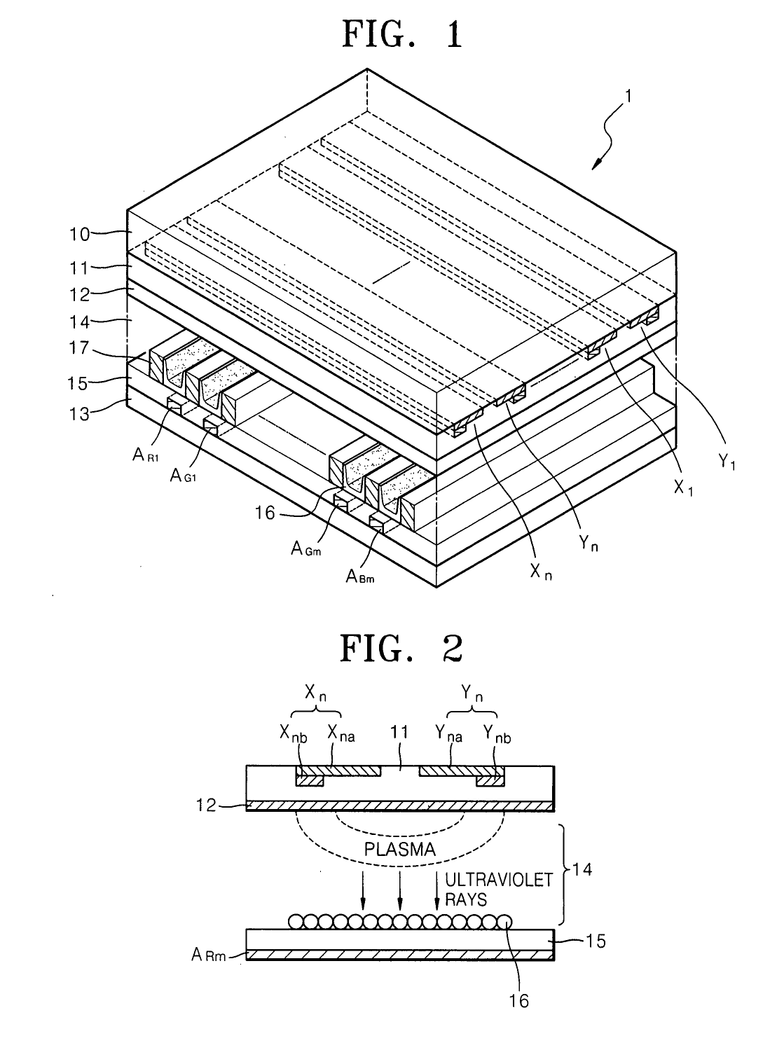

FIG. 1 is a perspective view of a three-electrode surface discharge type plasma display panel (PDP) 1 operated according to one embodiment and FIG. 2 is a cross-sectional view of a unit cell of the PDP 1 illustrated in FIG. 1. Referring to FIGS. 1 and 2, the three-electrode surface discharge type PDP 1 includes address electrode-lines A_{R1} through A_{Bm}, dielectric layers 11 and 15, X electrode-lines X₁ through Xₙ, Y electrode-lines Y₁ through Yₙ, phosphor layers 16, barrier ribs 17, and an MgO protection layer 12, between facing front and rear glass substrates 10 and 13.

The address electrode-lines A_{R1} through A_{Bm} are formed in a predetermined pattern on the rear glass substrate 13. The lower dielectric layer 15 is formed to cover the address electrode-lines A_{R1} through A_{Bm}. The barrier ribs 17 are formed parallel to the address electrode-lines AR1 through ABm on the lower dielectric layer 15. The barrier ribs 17 partition discharge spaces of the respective discharge cells and prevent optical cross talk between the discharge cells. The phosphor layers 16 are interposed between the barrier ribs 17.

In the embodiment shown, X electrode-lines X₁ through Xₙ and the Y electrode-lines Y₁ through Yₙ are substantially uniformly formed on the rear surface of the front glass substrate 10 in such a manner as to intersect with the address electrode-lines A_{R1} through A_{Bm}. Each intersecting point defines corresponding discharge cells. Each of the X electrode-lines X₁ through Xₙ and the Y electrode-line Y₁ through Yₙ is formed by coupling transparent electrode-lines Xₙₐ and Yₙₐ that are formed of a transparent conductive material such as Indium Tin Oxide (ITO) respectively with metal electrode-lines X_{nb} and Y_{nb} so as to increase conductivity. The front dielectric layer 11 is formed to cover the rear of the X electrode-lines X₁ through Xₙ and the Y electrode-lines Y₁ through Yₙ. The protection layer 12 protecting the PDP 1 from a strong electric field, for example, an MgO layer, is formed on the rear surface of the front dielectric layer 11. A plasma forming gas is filled in discharge spaces 14.

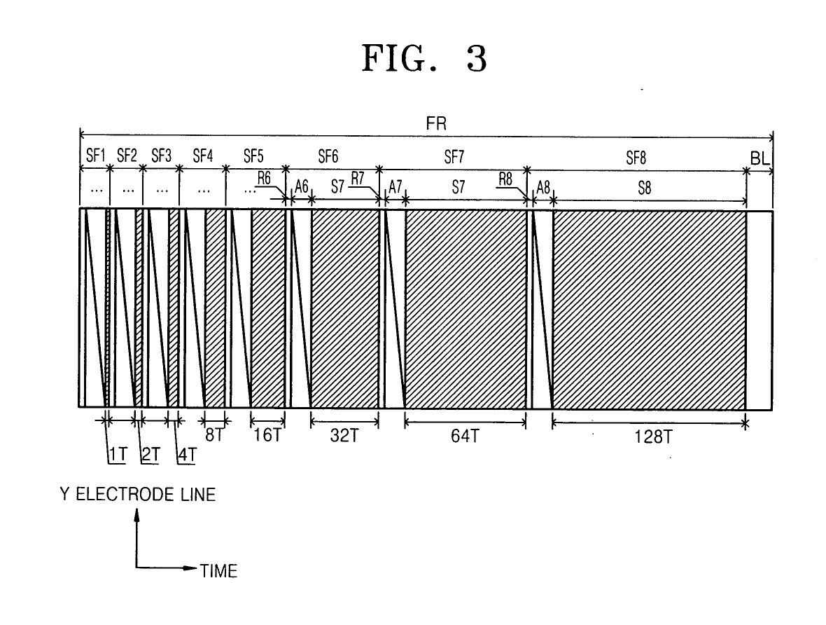

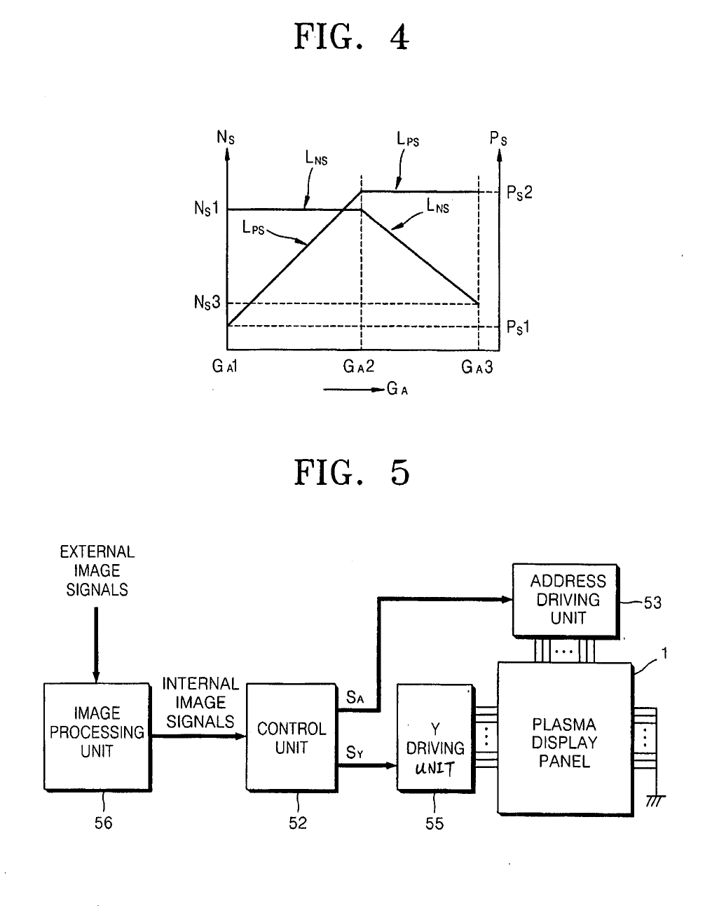

FIG. 3 is a timing diagram illustrating a method of driving the PDP 1 illustrated in FIG. 1 according to an embodiment. FIG. 4 is a waveform diagram illustrating an automatic power control method included in the method illustrated in FIG. 3. Referring to FIG. 4, G_{A} denotes an average gray-scale of each frame. N_{S} denotes data of the number of sustain pulses of each frame. P_{S} denotes driving power of each frame during a sustaining period. L_{NS} denotes a characteristics graph of the number of sustain pulses for the average gray-scale of each frame. L_{PS} denotes a characteristics graph of the driving power of each frame during the sustaining period. The method of driving the PDP 1 will now be described with reference to FIGS. 3 and 4.

In order to realize a time ratio gray-scale display, a unit frame FR can be divided into eight sub-fields SF1 through SF8. In addition, each of the sub-fields SF1 through SF8 can be divided into reset periods R1 through R8, addressing periods A1 through A8, and discharge-sustaining periods S1 through S8.

In each of the reset periods R1 through R8, discharge conditions for all discharge cells are reset to be uniform so that the discharge cells are suitable for addressing for the next period.

In each of the addressing periods A1 through A8, a display data signal is applied to the address electrode-lines A_{R1} through A_{Bm} and a scan pulse corresponding to each of the Y electrode-lines Y1 through Yn is sequentially applied to the address electrode-lines A_{R1} through A_{Bm} at the same time. Accordingly, if the display data signal with a high level is applied to the address electrode-lines A_{R1} through A_{Bm} while the scan pulse corresponding to each of the Y electrode-lines Y1 through Yn is applied to the address electrode-lines A_{R1} through A_{Bm}, wall charges for the discharge-sustaining periods S1 through S8 are formed in the corresponding discharge cells due to an addressing discharge. Otherwise, the wall charges are not formed in the corresponding discharge cells.

During each of the discharge-sustaining periods S1 through S8, sustain pulses are alternately applied to the Y electrode-lines Y1 through Yn and the X electrode-lines X₁ through Xₙ and thus, a display discharge occurs in the discharge cells in which the wall charges for the discharge-sustaining periods S1 through S8 are formed during each of the addressing periods A1 through A8. Accordingly, the brightness of the PDP is proportional to the duration of the discharge-sustaining periods S1 through S8, i.e., the number of sustain pulses, occupying the unit frame FR_{N}.

The available duration of the discharge-sustaining periods S1 through S8 occupying the unit frame FR_{N} is 255T, where T is a unit period. Therefore, the discharge-sustaining periods S1 through S8 can be displayed as 256 gray-scales including the case that the discharge-sustaining period is not displayed during the unit frame FR_{N}.

In some embodiments, the period 1T corresponding to 2⁰, the period 2T corresponding to 2¹, the period 4T corresponding to 2², the period 8T corresponding to 2³, the period 16T corresponding to 2⁴, the period 32T corresponding to 2⁵, the period 64T corresponding to 2⁶, and the period 128T corresponding to 2⁷ are set in a first sub-field SF₁ during the discharge-sustaining period S₁, a second sub-field SF₂ during the discharge-sustaining period S₂, a third sub-field SF₃ during the discharge-sustaining period S₃, a fourth sub-field SF₄ during the discharge-sustaining period S4, a fifth sub-field SF₅ during the discharge-sustaining period S5, a sixth sub-field SF₆ during the discharge-sustaining period S₆, a seventh sub-field SF₇ during the discharge-sustaining period S7, and an eighth sub-field SF₈ during the discharge-sustaining period S₈, respectively.

Accordingly, if a sub-field that is to be displayed is selected appropriately from the eight sub-fields SF₁ through SF₈, the display of all 256 gray-scales including a 0 gray-scale that does not display in any sub-field can be performed.

Power control will now be performed (refer to FIG. 4).

The number N_{S} of sustain pulses of each of the eight sub-fields SF₁ through SF₈ is established for each of frame having an average gray-scale value G_{A} smaller than a reference value G_{A}2 in proportion to gray-scale weighted values allocated to each of the sub-fields SF1 through SF8 and regardless of the average gray-scale value G_{A} of the frame.

The number N_{S} of sustain pulses of each of the eight sub-fields SF₁ through SF₈ is established for each frame having the average gray-scale value G_{A} higher than the reference value G_{A}2 in proportion to gray-scale weighted values allocated to each of the sub-fields SF1 through SF8 and in inverse proportion to the average gray-scale value G_{A} of each of frames in order to maintain a constant driving power P_{S} in the discharge-sustaining periods S1 through S8 of each of frames as a limit value P_{S}2.

Therefore, the number N_{S} of sustain pulses is reduced in proportion to the average gray-scale value G_{A} of each of frames having the average gray-scale value G_{A} higher than the reference value G_{A}2, resulting in the occurrence of a pause period BL between an end point of the last sub-field SF8 of each of frames and a beginning point of a next frame. Therefore, the higher the average gray-scale value G_{A} of a frame is, the longer the pause period BL is. Since no discharge occurs in the pause period BL, space charges and wall charges are removed from display cells in proportion to the pause period BL.

However, since a driving waveform of a reset period in the first sub-field SF1 of each frame varies on a regular basis, abnormal discharge conditions during each frames can be modified on a regular basis. For example, if a relatively small amount of space charges and wall charges are formed at a beginning point of the N^{th} frame due to a relatively long pause period BL of the N−1^{st} frame, the amount of space charges and wall charges can be appropriately supplemented via the driving waveform of the reset period in a first sub-field SF1 of the N^{th} frame. If a large amount of space charges and wall charges are formed at an end point of the N^{th} frame due to a relatively short pause period BL of the N^{th} frame, the amount of space charges and wall charges can be appropriately reduced via the driving waveform of a reset period in a first sub-field SF1 of an N+1^{st} frame.

That is, a result similar to the condition when the pause period does not occur can be obtained. Therefore, it is highly possible that proper discharges occur in the addressing periods A1 through A8 and the discharge-sustaining periods S1 through S8, thereby increasing presentation quality of a display image. The variation of the driving waveform will be described in detail with reference to FIGS. 6 through 12.

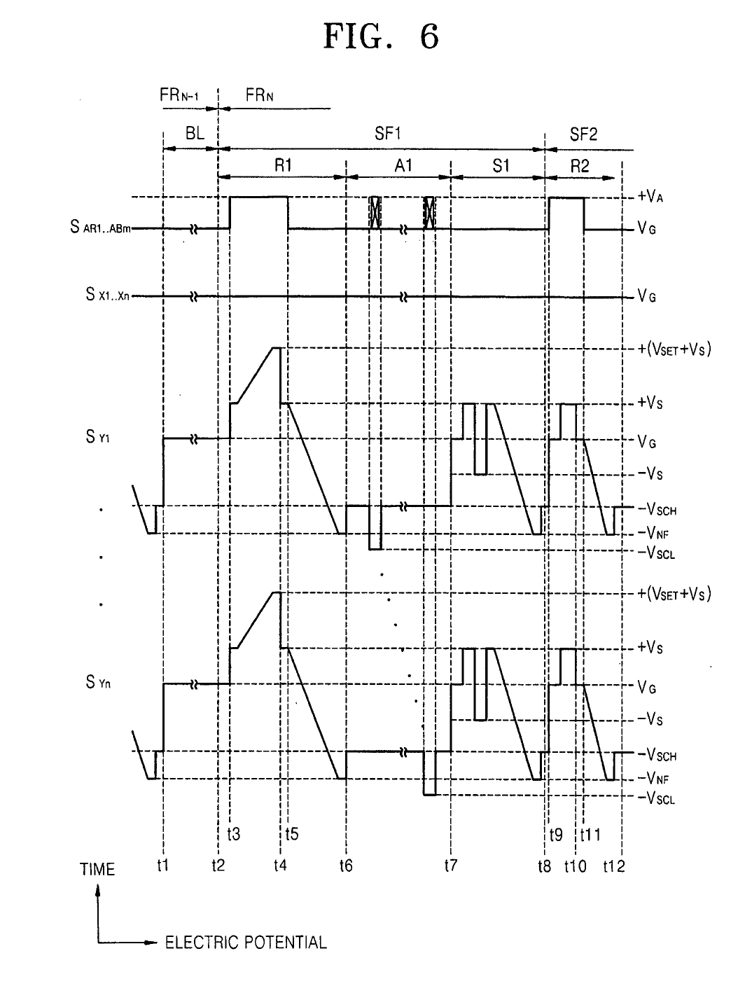

FIG. 5 is a block diagram illustrating an apparatus for driving the PDP 1 using the method illustrated in FIG. 3 according to an embodiment. Referring to FIG. 5, the apparatus includes an image processing unit 56, a control unit 52, an address driving unit 53, and a Y driving unit 55.

The image processing unit 56 converts external analog image signals into digital signals so as to generate internal image signals, for example, 8 bit red (R), green (G), and blue (B) image data, clock signals, and vertical and horizontal sync signals. The control unit 52 generates driving control signals S_{A}, S_{Y}, and S_{X} according to the internal image signals of the image processing unit 56.

The address driving unit 53 processes the address driving control signals S_{A} from the driving control signals S_{A}, S_{Y}, and S_{X} in order to generate display data signals and to apply the display data signals to the address electrode-lines A_{R1} through A_{Bm}. The Y driving unit 55 processes the driving control signals S_{Y} from the control signals S_{A}, S_{Y}, and S_{X} so as to operate the Y electrode-lines Y₁ through Yₙ.

Meanwhile, since a ground electric potential V_{G} (shown in FIG. 6) is applied to the X electrode-lines X₁ through Xₙ, the X electrode-lines X₁ through Xₙ do not need an X driving unit, thereby reducing manufacturing costs of the PDP 1. However, the address electrode-lines A_{R1} through A_{Bm}, the Y electrode-lines Y₁ through Yₙ, and the X electrode-lines X₁ through Xₙ can be driven by controlling the address electrode-lines A_{R1} through A_{Bm} and the Y electrode-lines Y₁ through Yₙ, which shows an advantage of the method of driving the PDP 1.

FIG. 6 is a waveform diagram illustrating driving signals used from the beginning of the N^{th} frame FR_{N} to the end of the N−1^{st} frame FR_{N-1}, according to an embodiment. Referring to FIG. 6, driving signals S_{AR1} through S_{ABm} are applied to each of the address electrode-lines A_{R1} through A_{Bm}. Driving voltages, i.e., ground electric potential V_{G}, S_{X1} through S_{Xn} are applied to the X electrode-lines X1 through Xn. Driving signals S_{Y1} through S_{Yn} are applied to the Y electrode-lines Y₁ through Yₙ.

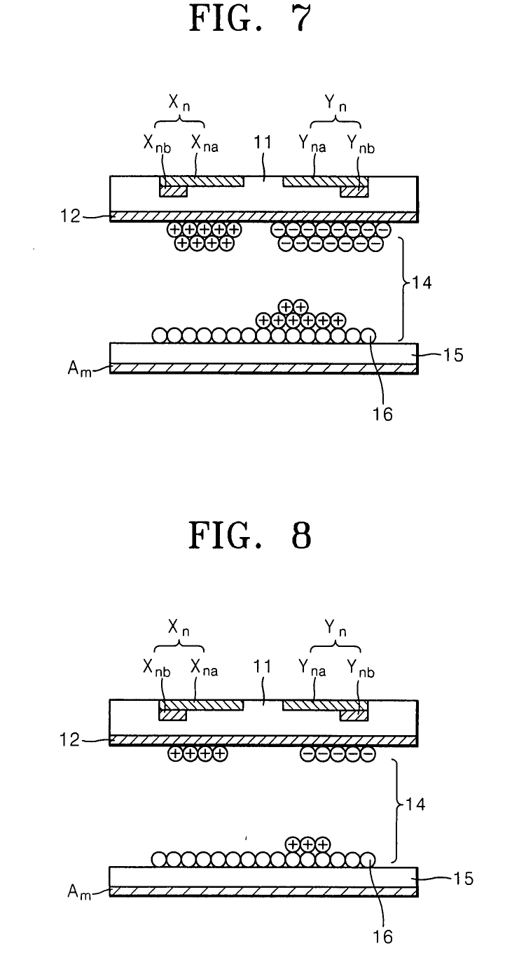

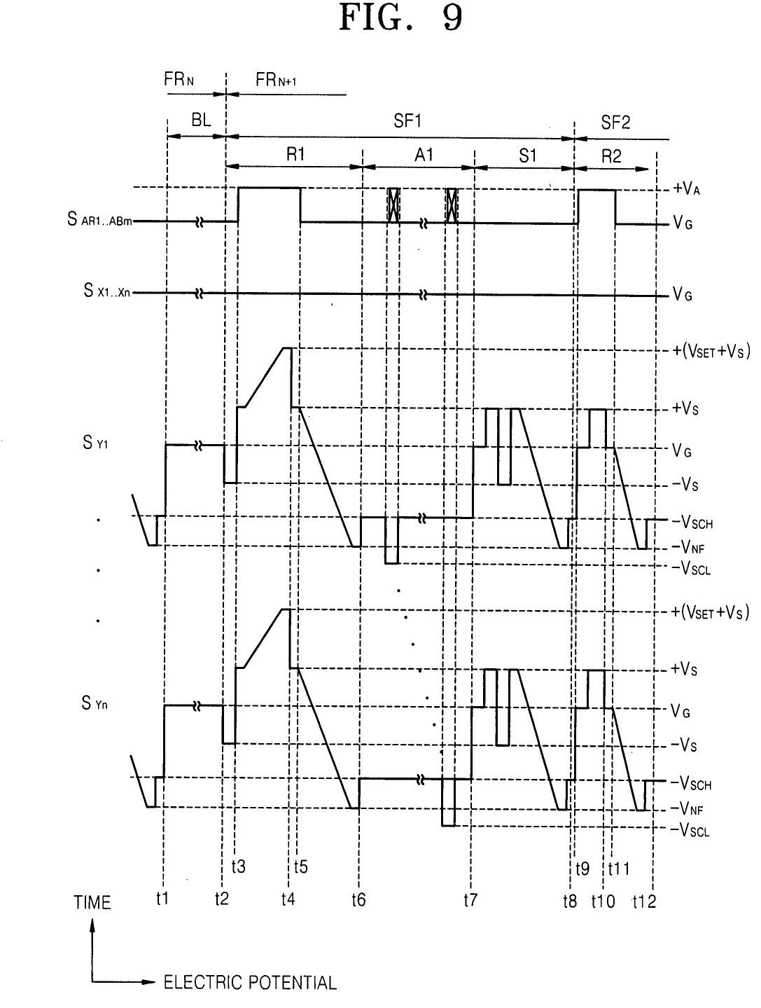

FIG. 7 is a cross-sectional diagram illustrating a wall charge distribution of one of the display cells of the PDP at time t4 of the waveform diagram illustrated in FIG. 6, according to an embodiment. FIG. 8 is a cross-sectional diagram illustrating a wall charge distribution of one of the display cells of the PDP at time t6 of the waveform diagram illustrated in FIG. 6, according to an embodiment. In FIGS. 7 and 8, the same references as those of FIG. 2 refer to objects having the same or similar functions.

Referring to FIGS. 3, 4, and 6, the number N_{S} of sustain pulses is reduced in proportion to the average gray-scale value G_{A} of the N−1^{st} frame FR_{N-1} having the average gray-scale value G_{A} higher than the reference value G_{A}2, resulting in the occurrence of the pause period BL between end time t1 of the last sub-field SF8 of the N−1^{st} frame FR_{N-1} and beginning time t2 of the N^{th} frame FR_{N}. Since the ground voltages V_{G} are applied to all electrode-lines in the pause period BL, no discharge occurs in the display cells.

During a wall charge forming period t2 through t4 during the reset period R1 of the first sub-field SF1 of the N^{th} frame FR_{N}, an electric potential having a positive polarity that is applied to the Y electrode-lines Y₁ through Yₙ rises from the ground voltage V_{G} to a second electric potential +(V_{SET}+V_{S}), for example, 355 volts (V). In more detail, the electric potential having a positive polarity that is applied to the Y electrode-lines Y₁ through Yₙ rises from the ground voltage V_{G} to a first electric potential +V_{S} at time t3. At times t3 and t4 the electric potential having a positive polarity that is applied to the Y electrode-lines Y₁ through Yₙ gradually rises from the first electric potential +V_{S} to the second electric potential +(V_{SET}+V_{S}). The ground voltage V_{G} is applied to the X electrode-lines X₁ through Xₙ and a selection voltage +V_{A} is applied to the address electrode-lines A_{R1} through A_{Bm} during the wall charge forming period t2 through t4.

Accordingly, a discharge occurs between the Y electrode-lines Y₁ through Yₙ and the X electrode-lines X₁ through Xₙ while a discharge occurs between the Y electrode-lines Y₁ through Yₙ and the address electrode-lines A_{R1} through A_{Bm}. Therefore, wall charges with a negative polarity are formed around the Y electrode-lines Y₁ through Yₙ, wall charges with a positive polarity are formed around the X electrode-lines X₁ through Xₙ, and wall charges with a positive polarity are formed around the address electrode-lines A_{R1} through A_{Bm} (refer to FIG. 7).

Then, during a wall charge distributing period t4 through t6 during the reset period R1 of the first sub-field SF1 of N^{th} frame FR_{N}, while the ground voltage V_{G} is applied to the X electrode-lines X₁ through Xₙ and the address electrode-lines A_{R1} through A_{Bm}, the electric potential that is applied to the Y electrode-lines Y₁ through Yₙ falls to a third electric potential −V_{NF} with a negative polarity from the second electric potential +(V_{SET}+V_{S}). In more detail, the electric potential having a positive polarity that is applied to the Y electrode-lines Y₁ through Yₙ falls to the first electric potential +V_{S} from the second electric potential +(V_{SET}+V_{S}) at time t4. At times t5 and t6 the electric potential that is applied to the Y electrode-lines Y₁ through Yₙ falls to the third electric potential −V_{NF} with a negative polarity from the first electric potential +V_{S} with a positive polarity.

Accordingly, due to discharge occurring between the X electrode-lines X₁ through Xₙ, the Y electrode-lines Y₁ through Yₙ, and address electrode-lines A_{R1} through A_{Bm}, the number of wall charges decreases (refer to FIG. 8).

The following method of driving the PDP 1 during the addressing period A1 is applied to the other addressing periods A2 through A8 in the same manner.

Another aspect is an absolute value of a scan-bias electric potential −V_{SCH} with a negative polarity applied to the Y electrode-lines Y₁ through Yₙ is smaller than that of the third electric potential −V_{NF} with a negative polarity and larger than that of a fourth electric potential −V_{S} with a negative polarity. Another aspect is an absolute value of a scan-pulse electric potential −V_{SCL} with a negative polarity applied to the Y electrode-lines Y₁ through Yₙ is larger than that of the third electric potential −V_{NF} with a negative polarity.

During the addressing period A1 of the first sub-field SF1 of the N^{th} frame FR_{N}, a display data signal is applied to the address electrode-lines A_{R1} through A_{Bm} and a scan pulse of the scan-pulse electric potential −V_{SCL} with a negative polarity is sequentially applied to the Y electrode-lines Y₁ through Yₙ biased to the scan-bias electric potential −V_{SCH} with a negative polarity, thereby performing addressing discharge. The display data signal is applied to each of the address electrode-lines A_{R1} through A_{Bm} as the selection voltage +V_{A} with a positive polarity when the discharge cell is selected and as the ground voltage V_{G} when the discharge cell is not selected.

Therefore, if the selection voltage +V_{A} with a positive polarity is applied while the scan pulse of the scan-pulse electric potential −V_{SCL} with a negative polarity is applied, wall charges are formed due to an address discharge in the corresponding discharge cells, and the address discharge does not occur in the other discharge cells.

The following method of driving the PDP1 during the discharge-sustaining period S1 is applied to the other discharge-sustaining periods S2 through S8 in the same manner.

During the discharge-sustaining period S1 of the first sub-field SF1 of the N^{th} frame FR_{N}, when the address electrode-lines A_{R1} through A_{Bm} are biased with the selection voltage +V_{A}, and the ground voltage V_{G} is applied to the X electrode-lines X₁ through Xₙ, the first electric potential +V_{S} with a positive polarity and the fourth electric potential −V_{S} with a negative polarity are alternately applied to the Y electrode-lines Y₁ through Yₙ.

Therefore, a surface discharge which is a sustain discharge occurs in the X electrode-lines X₁ through Xₙ and the Y electrode-lines Y₁ through Yₙ of the discharge cells in which wall charges are formed during the preceding addressing period A.

At the end of the discharge-sustaining period S1, the electric potential that is applied to the Y electrode-lines Y₁ through Yₙ gradually falls to the third electric potential −V_{NF} with a negative polarity from the first electric potential +V_{S} with a positive polarity, thereby starting a reset operation in the second sub-field SF2.

The following reset operation in the second sub-field SF2 is applied during the reset periods R2 through R8 of the sub-fields SF2 through SF8.

In summary, resetting is performed in the display cells with a relatively strong power in the reset period R1 of the first sub-field SF1, whereas resetting is performed in display cells where the sustain discharge previously occurs with a relatively weak power in each of the reset periods R2 through R8 of the sub-fields SF2 through SF8, thereby increasing contrast performance of a plasma display device.

The operation of the reset period R2 of the second sub-field SF2 will now be described.

During a wall charge forming period t8 through t10 during the reset period R2 of the second sub-field SF2 of the N^{th} frame FR_{N}, an electric potential that is applied to the Y electrode-lines Y₁ through Yₙ rises from the scan-bias electric potential −V_{SCH} with a negative polarity to the first electric potential +V_{S} with a positive polarity. In more detail, the electric potential rises from the scan-bias electric potential −V_{SCH} with a negative polarity to the ground voltage V_{G} to the first electric potential +V_{S} with a positive polarity. The ground voltage V_{G} is applied to the X electrode-lines X₁ through Xₙ and the selection voltage +V_{A} is applied to the address electrode-lines A_{R1} through A_{Bm} during the wall charge forming period t8 through t10.

Therefore, in each of the display cells where the sustain discharge occurs in the discharge-sustaining period S1 of the first sub-field SF1, a discharge occurs between the X electrode-lines X₁ through Xₙ and the Y electrode-lines Y₁ through Yₙ, and a discharge occurs between the Y electrode-lines Y₁ through Yₙ and the address electrode-lines A_{R1} through A_{Bm}. Therefore, in each of the display cells where the sustain discharge occurs in the discharge-sustaining period S1 of the first sub-field SF1, wall charges with a negative polarity are formed around the Y electrode-lines Y₁ through Yₙ, and wall charges with a positive polarity are formed around the X electrode-lines X₁ through Xₙ and the address electrode-lines A_{R1} through A_{Bm} (refer to FIG. 7).

Then, during a wall charge distributing period t10 through t12 during the reset period R2 of the second sub-field SF2 of N^{th} frame FR_{N}, while the ground voltage V_{G} is applied to the X electrode-lines X₁ through Xₙ and the address electrode-lines A_{R1} through A_{Bm}, the electric potential that is applied to the Y electrode-lines Y₁ through Yₙ falls to the third electric potential −V_{NF} with a negative polarity from the first electric potential +V_{S} with a positive polarity. In more detail, the electric potential that is applied to the Y electrode-lines Y₁ through Yₙ falls to the ground voltage V_{G} from the first electric potential +V_{S} with a positive polarity at time t10. At times t11 and t12 the electric potential that is applied to the Y electrode-lines Y₁ through Yₙ falls to the third electric potential −V_{NF} with a negative polarity from the first electric potential +V_{S} with a positive polarity.

Accordingly, due to discharge occurring between the X electrode-lines X₁ through Xₙ, the Y electrode-lines Y₁ through Yₙ, and the address electrode-lines A_{R1} through A_{Bm} in each of the display cells where the sustain discharge occurs in the discharge-sustaining period S1 of the first sub-field SF1, the number of wall charges decreases (refer to FIG. 8).

FIG. 9 is a waveform diagram illustrating driving signals between the beginning of an N+1^{st} frame FR_{N+1} and the end of the N^{th} frame FR_{N}, according to an embodiment. Referring to FIG. 9, the same references as those of FIG. 6 refer to objects having the same or similar functions.

During a wall charge forming period t2 through t4 of the reset period R1 of the first sub-field SF1 of the N+1^{st} frame FR_{N+1}, an electric potential that is applied to the Y electrode-lines Y₁ through Yₙ rises from a fourth electric potential −V_{S} with a negative polarity to a first electric potential +V_{S} with a positive polarity. Therefore, a greater amount of wall charges are formed with a driving waveform of the reset period R1 of the first sub-field SF1 of the N+1^{st} frame FR_{N+1} than those formed with the driving waveform of the reset period R1 of the first sub-field SF1 of the N^{th} frame FR_{N} illustrated in FIG. 6.

If a relatively smaller amount of space charges and wall charges are formed at beginning time t2 of the N+1^{st} frame FR_{N+1} due to the relatively long pause period BL of the N^{th} frame FR_{N}, the amount of space charges and wall charges can be appropriately modified with the driving waveform of the reset period R1 of the first sub-field SF1 of the N+1^{st} frame FR_{N+1}.

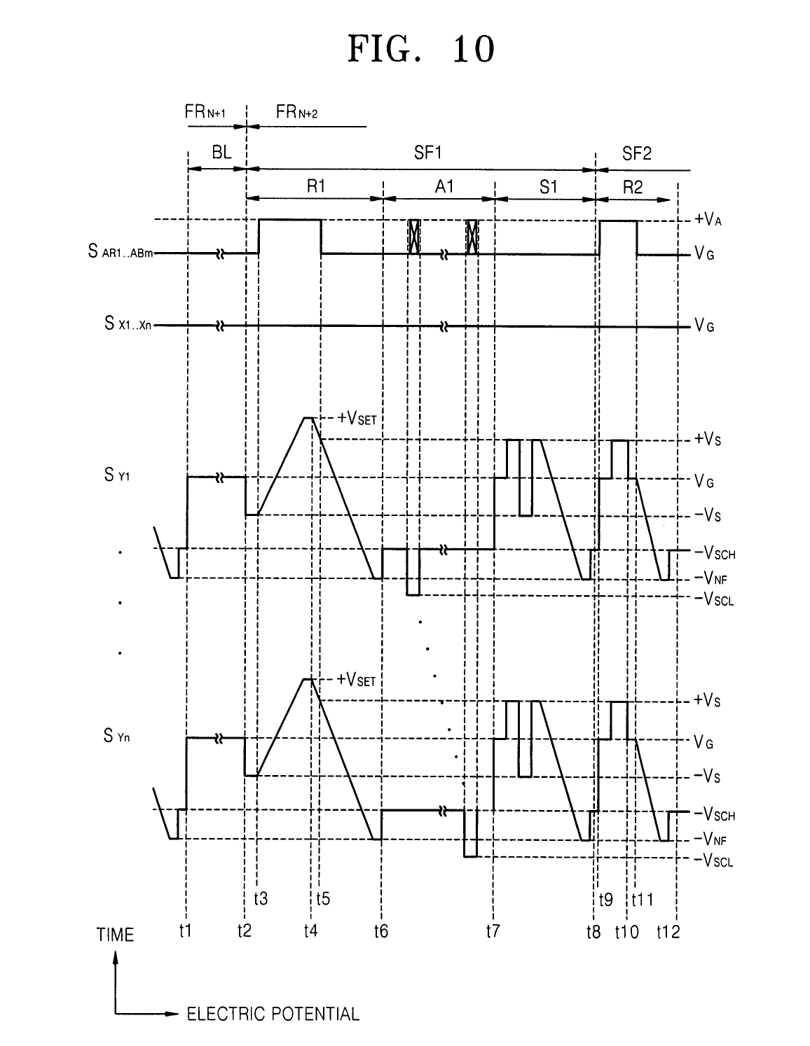

FIG. 10 is a waveform diagram illustrating driving signals between the beginning of an N+2^{nd} frame FR_{N+2} and the end of the N+1^{st} frame FR_{N+1}, according to an embodiment. Referring to FIG. 9, the same references as those of FIG. 6 refer to objects having the same or similar functions.

During a wall charge forming period t2 through t4 of the reset period R1 of the first sub-field SF1 of the N+2^{nd} frame FR_{N+2}, an electric potential that is applied to the Y electrode-lines Y₁ through Yₙ rises from a fourth electric potential −V_{S} with a negative polarity to a fifth electric potential +V_{SET} with a positive polarity lower than a second electric potential +(V_{SET}+V_{S}) with a positive polarity.

During a wall charge distributing period t4 through t6, the electric potential that is applied to the Y electrode-lines Y₁ through Yₙ falls to a third electric potential −V_{NF} with a negative polarity from the fifth electric potential +V_{SET} with a positive polarity.

Therefore, a smaller amount of wall charges are formed with a driving waveform of the reset period R1 of the first sub-field SF1 of the N+2^{nd} frame FR_{N+2} than those formed with the driving waveform of the reset period R1 of the first sub-field SF1 of the N^{th} frame FR_{N} illustrated in FIG. 6.

If a relatively large amount of space charges and wall charges are formed at beginning time t2 of the N+2^{nd} frame FR_{N+2} due to the reset period R1 of the first sub-field SF1 of the N+1^{st} frame FR_{N+1} or the relatively short pause period BL of the N+1^{st} frame FR_{N+1}, the amount of space charges and wall charges can be appropriately modified via the driving waveform of the reset period R1 of the first sub-field SF1 of the N+2^{nd} frame FR_{N+2}.

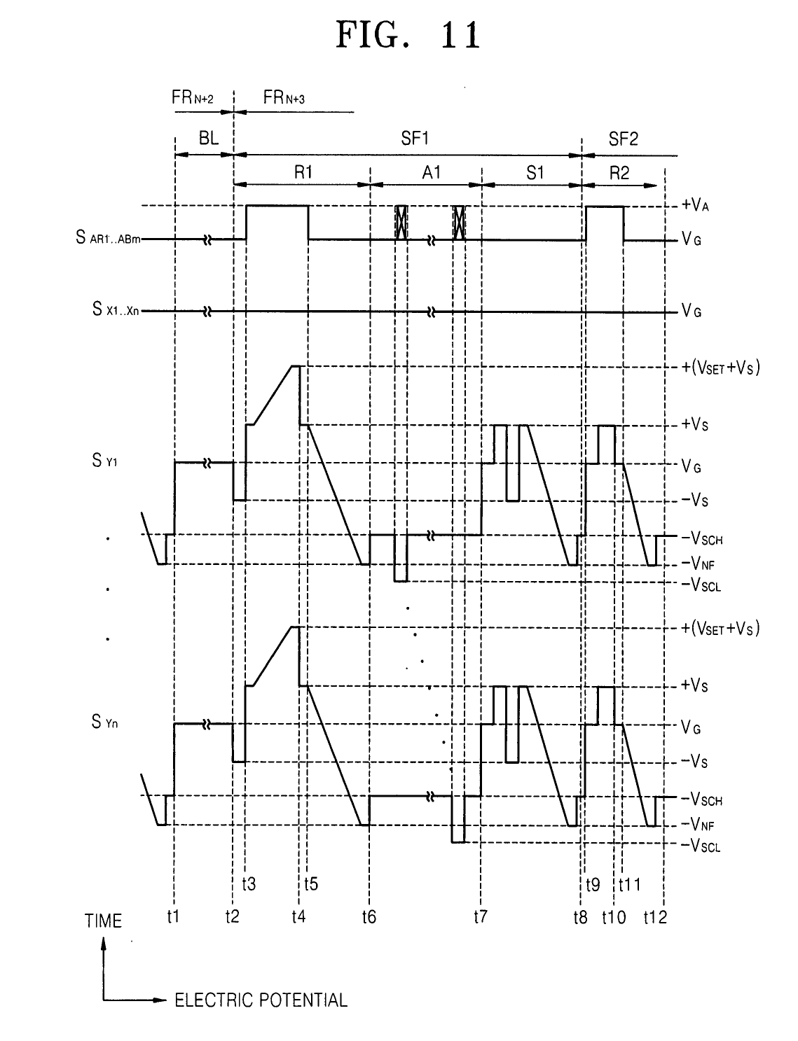

FIG. 11 is a waveform diagram illustrating driving signals between the beginning of an N+3^{rd} frame FR_{N+3} and the end of the N+2^{nd} frame FR_{N+2}, according to an embodiment. Referring to FIG. 11, the same references as those of FIG. 6 refer to objects having the same or similar functions. Both waveforms illustrated in FIGS. 6 and 11 are identical to each other. Therefore, the effect thereof will now be described.

If a relatively small amount of space charges and wall charges are formed at beginning time t2 of the N+3^{rd} frame FR_{N+3} due to the reset period R1 of the first sub-field SF1 of the N+2^{nd} frame FR_{N+2} or the relatively long pause period BL of the N+2^{nd} frame FR_{N+2}, the amount of space charges and wall charges can be appropriately modified via the driving waveform of the reset period R1 of the first sub-field SF1 of the N+3^{rd} frame FR_{N+3}.

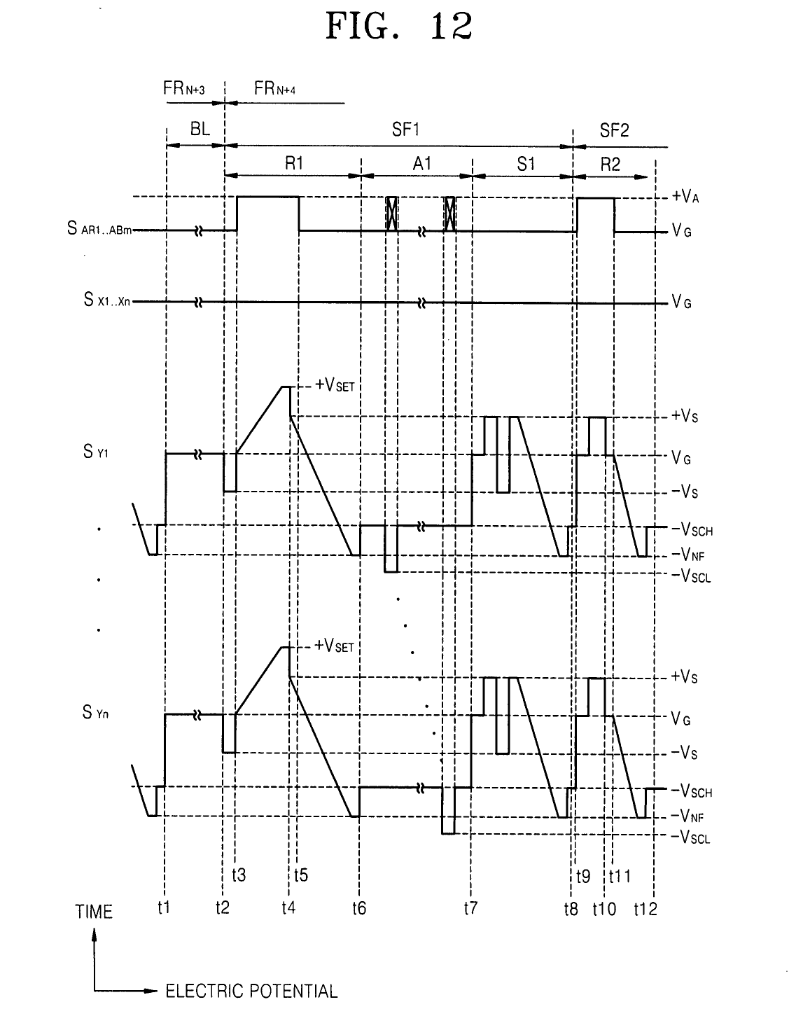

FIG. 12 is a waveform diagram illustrating driving signals between the beginning of an N+4^{th} frame FR_{N+4} and the end of the N+₃^{rd} frame FR_{N+3}, according to an embodiment. Referring to FIG. 12, the same references as those of FIG. 6 refer to objects having the same or similar functions. Therefore, differences between the waveform diagrams illustrated in FIGS. 6 and 12 will now be described.

During a wall charge forming period t2 through t4 during the reset period R1 of the first sub-field SF1 of the N+4^{th} frame FR_{N+4}, an electric potential that is applied to the Y electrode-lines Y₁ through Yₙ rises from a fourth electric potential −V_{S} with a negative polarity to a fifth electric potential +V_{SET} with a positive polarity. In more detail, the electric potential that is applied to the Y electrode-lines Y₁ through Yₙ rises from a ground voltage V_{G} to the fourth electric potential −V_{S} with a negative polarity at time t3. At times t3 and t4 the electric potential that is applied to the Y electrode-lines Y₁ through Yₙ rises from the ground voltage V_{G} to the fifth electric potential +V_{SET} with a positive polarity.

During a wall charge distributing period t4 through t6 during the reset period R1 of the first sub-field SF1 of N+4^{th} frame FR_{N+4}, the electric potential that is applied to the Y electrode-lines Y₁ through Yₙ falls to the ground voltage V_{G} from the fifth electric potential +V_{SET} with a positive polarity. At times t5 and t6 the electric potential that is applied to the Y electrode-lines Y₁ through Yₙ gradually falls to the third electric potential −V_{NF} with a negative polarity from the ground voltage V_{G}.

Therefore, a smaller amount of wall charges are formed with a driving waveform of the reset period R1 of the first sub-field SF1 of the N+4^{th} frame FR_{N+4} than those formed with the driving waveform of the reset period R1 of the first sub-field SF1 of the N^{th} frame FR_{N} illustrated in FIG. 6.

If a relatively large amount of space charges and wall charges are formed at beginning time t2 of the N+4^{th} frame FR_{N+4} due to the reset period R1 of the first sub-field SF1 of the N+3^{rd} frame FR_{N+3} or the relatively short pause period BL of the N+3^{rd} frame FR_{N+3}, the amount of space charges and wall charges can be appropriately modified via the driving waveform of the reset period R1 of the first sub-field SF1 of the N+4^{th} frame FR_{N+4}.

The reset waveforms of the N^{th} through N+4^{th} frames FR_{N} through FR_{N+4} may repeat in a five frame unit.

A method of driving a discharge display panel according to these and other embodiments can control a driving power via a power control operation and increase presentation quality of a display image with a resetting operation.

In the power control operation, a pause period is generated between end time of a last sub-field of each frame and beginning time of a next frame. Since no discharge occurs in the pause period, space charges and wall charges are removed from display cells in proportion to the pause period.

However, since in the first resetting operation a driving waveform of a reset period of a first sub-field varies on a regular basis, abnormal discharge conditions of each frame can be modified on a regular basis. For example, if a relatively small amount of space charges and wall charges are formed at a beginning point of the N^{th} frame due to a relatively long pause period BL of the N−1^{st} frame, the amount of space charges and wall charges can be appropriately supplemented via the driving waveform of the reset period in a first sub-field SF1 of the N^{th} frame. If a large amount of space charges and wall charges are formed at an end point of the N^{th} frame due to a relatively short pause period BL of the N^{th} frame, the amount of space charges and wall charges can be appropriately reduced via the driving waveform of a reset period in a first sub-field SF1 of an N+1^{st} frame.

That is, a result similar to when the pause period does not occur can be obtained. Therefore, it is highly possible that proper discharges occur in addressing periods and discharge-sustaining periods, thereby increasing presentation quality of a display image.

In some embodiments, the ground electric potential V_{G} is applied to the X electrode-lines X₁ through Xₙ, as illustrated in FIGS. 5, 6, and 9 through 12; however, a another driving signal can be applied to the X electrode-lines X₁ through Xₙ. In this case, an electric potential having a relatively low absolute value may be applied to the Y electrode-lines Y₁ through Yₙ.

While certain embodiments have been particularly shown and described with reference to the figures, it will be understood by one of ordinary skill in the art that various changes in form and details may be made therein without departing from the spirit and scope of the present invention.

What is claimed is:

1. A method of driving a discharge display panel comprising sustain electrode-lines, scanning electrode-lines formed alternately with the sustain electrode-lines, address electrode-lines formed to cross the sustain electrode-lines and the scanning electrode-lines, and display cells formed near the crossing electrode-lines,
wherein a unit frame is divided into a plurality of sub-fields, each of the sub-fields comprising a reset period, an addressing period, and a discharge-sustaining period, one or more sustain pulses applied during the discharge-sustaining period while a constant electric potential is applied to the sustain electrode-lines, the method comprising:
controlling the number of sustain pulses established in the discharge-sustaining period of each of the sub-fields in proportion to corresponding gray-scale weighted values of each of the sub-fields and in inverse proportion to average gray-scales of each frame, and
varying a driving waveform of a reset period of a first sub-field in a unit frame.

2. The method of claim 1, wherein the driving waveform is varied regularly.

3. The method of claim 1, wherein during an occurrence of the first resetting operation, during a reset period of the first sub-field of a frame,
applying an electric signal to the scanning electrode-lines, the electric signal:
rising from a ground electric potential (V_{G}) to a first electric potential (+V_{S}) with a positive polarity;
rising from the first electric potential (+V_{S}) with a positive polarity to a second electric potential [+(V_{SET}+V_{S})] with a positive polarity
falling from the second electric potential [+(V_{SET}+V_{S})] with a positive polarity to the first electric potential (+V_{S}) with a positive polarity; and
falling from the first electric potential (+V_{S}) with a positive polarity to a third electric potential (−V_{NF}) with a negative polarity.

4. The method of claim 3, wherein, during the addressing period of each of the sub-fields, the absolute value of the scan-pulse electric potential (−V_{SCL}) with a negative polarity applied to the scanning electrode-lines is greater than an absolute value of the third electric potential (−V_{NF}) with a negative polarity.

5. The method of claim 3, wherein during a final portion of the discharge-sustaining period of each of the sub-fields, the electric signal applied to the scanning electrode-lines falls to the third electric potential (−V_{NF}) with a negative polarity from the first electric potential (+V_{S}) with a positive polarity.

6. The method of claim 3, wherein during a final portion of the discharge-sustaining period of one or more of the sub-fields,
an electric signal is applied to the scanning electrode-lines, the electric signal:
rising from a fourth potential (−V_{S}) with a negative polarity to the first electric potential (+V_{S}) with a positive polarity; and
falling from the first electric potential (+V_{S}) with a positive polarity to the third electric potential (−V_{NF}) with a negative polarity.

7. The method of claim 1, wherein, during a first occurrence of the first resetting operation, during a reset period of the first sub-field of a frame,
an electric signal is applied to the scanning electrode-lines, the electric signal:
rising from a fourth electric potential (−V_{S}) with a negative polarity to a first electric potential (+V_{S}) with a positive polarity;
rising from the first electric (+V_{S}) potential with a positive polarity to a second electric potential [+(V_{SET}+V_{S})] with a positive polarity;
falling from the second electric potential [+(V_{SET}+V_{S})] with a positive polarity to the first electric potential with a positive polarity (+V_{S}); and
falling from the first electric potential (+V_{S}) with a positive polarity to a third electric potential (−V_{NF}) with a negative polarity.

8. The method of claim 7, wherein, during the addressing period of each of the sub-fields, an absolute value of a scan-bias electric potential (−V_{SCH}) with a negative polarity −V_{SCH} applied to the scanning electrode-lines is less than an absolute value of the third electric potential (−V_{NF}) with a negative polarity and greater than an absolute value of the fourth electric potential (−V_{S}) with a negative polarity −V_{S}.

9. The method of claim 7 wherein, during the addressing period of each of the sub-fields, the absolute value of the scan-pulse electric potential (−V_{SCL}) with a negative polarity applied to the scanning electrode-lines is greater than an absolute value of the third electric potential (−V_{NF}) with a negative polarity.

10. The method of claim 7 wherein, during the discharge-sustaining period of one or more of the sub-fields, the first electric potential (+V_{S}) with a positive polarity and the fourth electric potential (−V_{S}) with a negative polarity are alternately applied to the scanning electrode-lines.

11. The method of claim 7, wherein during a second occurrence of the first resetting operation, during a reset period of the first sub-field of a frame,
another electric signal is applied to the scanning electrode-lines, the other electric signal:
rising from the fourth electric (−V_{S}) potential with a negative polarity to a fifth electric potential (+V_{SET}) with a positive polarity, the fifth electric potential (+V_{SET}) being lower than the second electric potential [+(V_{SET}+V_{S})] with a positive polarity; and
falling from the fifth electric potential (+V_{SET}) with a positive polarity to the third electric potential (−V_{NF}) with a negative polarity.

12. The method of claim 11, wherein, during the addressing period of each of the sub-fields, an absolute value of a scan-bias electric potential (−V_{SCH}) with a negative polarity applied to the scanning electrode-lines is less than an absolute value of the third electric potential (−V_{NF}) with a negative polarity and greater than an absolute value of the fourth electric potential (−V_{S}) with a negative polarity.

13. The method of claim 11, wherein, during the addressing period of each of the sub-fields, the absolute value of the scan-pulse electric potential (−V_{SCL}) with a negative polarity applied to the scanning electrode-lines is greater than an absolute value of the third electric potential (−V_{NF}) with a negative polarity.

14. The method of claim 11 wherein, during the discharge-sustaining period of one or more of the sub-fields, the first electric potential (+V_{S}) with a positive polarity and the fourth electric potential (−V_{S}) with a negative polarity are alternately applied to the scanning electrode-lines.

15. The method of claim 1, wherein, during an occurrence of the first resetting operation, during a reset period of the first sub-field of a frame,
an electric signal is applied to the scanning electrode-lines, the electric signal:
rising from a fourth electric potential (−V_{S}) with a negative polarity to a ground electric potential (V_{G});
rising from the ground electric potential (V_{G}) to a fifth electric potential (+V_{SET}) with a positive polarity;
falling from the fifth electric potential (+V_{SET}) with a positive polarity to a first electric potential (+V_{S}) with a positive polarity; and
falling from the first electric potential (+V_{S}) to a third electric potential (−V_{NF}) with a negative polarity.

16. The method of claim 15, wherein, during the addressing period of each of the sub-fields, an absolute value of a scan-bias electric potential (−V_{SCH}) with a negative polarity applied to the scanning electrode-lines is less than an absolute value of the third electric potential (−V_{NF}) with a negative polarity and greater than an absolute value of the fourth electric potential (−V_{S}) with a negative polarity.

17. The method of claim 15, wherein, during the addressing period of each of the sub-fields, the absolute value of the scan-pulse electric potential (−V_{SCL}) with a negative polarity applied to the scanning electrode-lines is greater than an absolute value of the third electric potential (−V_{NF}) with a negative polarity.

18. The method of claim 15, wherein, during the discharge-sustaining period of one or more of the sub-fields, the first electric potential (+V_{S}) with a positive polarity and the fourth electric potential (−V_{S}) with a negative polarity are alternately applied to the scanning electrode-lines.

19. The method of claim 15, wherein, at end time of the discharge-sustaining period of each of the sub-fields, the electric signal applied to the scanning electrode-lines falls to the third electric potential (−V_{NF}) with a negative polarity from the first electric potential (+V_{S}) with a positive polarity.

20. The method of claim 19, wherein, at end time of the discharge-sustaining period of one or more of the sub-fields,
an electric signal is applied to the scanning electrode-lines, the electric signal:
rising from the fourth electric potential (−V_{S}) with a negative polarity −V_{S} to the first electric potential (+V_{S}) with a positive polarity; and
falling from the first electric potential (+V_{S}) with a positive polarity to the third electric potential (−V_{NF}) with a negative polarity.

21. The method of claim 15, wherein, during a final portion of the discharge-sustaining period of one or more of the sub-fields,
an electric signal is applied to the scanning electrode-lines, the electric signal:
rising from the fourth electric potential (−V_{S}) with a negative polarity to the first electric potential (+V_{S}) with a positive polarity; and
falling from the first electric potential (+V_{S}) with a positive polarity to the third electric potential (−V_{NF}) with a negative polarity.
